(19) United States
(12) Patent Application Publication
(10) Pub. No.: US 2003/0087722 A1
(43) Pub. Date: May 8, 2003

(54) Continuously variable transmission

(76) Inventor: Peter Visscher, Dashwood (CA)

Correspondence Address: Richard J. Parr, Bereskin & Parr, 40 King Street West, Box 401, Toronto, ON, M5H 3Y2, CA

(21) Appl. No.: 09/986,257

(22) Filed: Nov. 8, 2001

(51) Int. Cl. F16H 15/38

(52) U.S. Cl. 476/40

(57) ABSTRACT

A continuously variable transmission, including a rotatable input shaft, an input disc, a rotatable output shaft, an output disc, and one or more power rollers. The input and output discs are connected to the input and output shafts respectively, so that the discs may move axially on the shafts, and so that the discs rotate with the shafts. The one or more power rollers operatively connect the input and output discs. The one or more power rollers are pivotally connected to a frame, which is connected to a stationary base. Axial movement of either of the input and output discs against the one or more power rollers changes the angle of the one or more power rollers against the input and output discs.

### FIELD OF THE INVENTION

The invention relates to continuously variable transmissions.

### BACKGROUND OF THE INVENTION

Continuously variable transmissions are transmissions having continuously variable ratios between the input and output. Some continuously variable transmissions, which are known as toroidal continuously variable transmissions, have an input disc connected to an input shaft, and an output disc, connected to an output shaft. The discs have generally partial toroidal surfaces that face each other and that are co-axial. Power rollers operatively connect the input and output discs and transfer power from the input disc to the output disc. The power rollers are adjustable in angle, which changes the tranmission ratio between the input and output discs. Typically, a continuously variable transmission has a complex linkage between a control device and the power rollers to change the angle of the power rollers. Furthermore, the transmission usually needs a complex mechanism to enable it to idle. Thus, a continuing need exists for improved continuously variable transmissions.

### SUMMARY OF THE INVENTION

In a first aspect, the invention is directed to a continuously variable transmission, including a rotatable input shaft, an input disc, a rotatable output shaft, an output disc, a frame, and at least one power roller. The input disc is mounted to the input shaft for rotation therewith and for axial movement thereon. The output disc is mounted to the output shaft for rotation therewith and for axial movement thereon. The frame is located between the input and output discs. The frame is fixed axially relative to the input and output discs. The at least one power roller is for operatively connecting the input disc and the output disc. The at least one power roller is mounted pivotally to the frame with an offset pivot so that the angle between the at least one power roller and the input and output discs is adjustable. Axial movement of either of the input and output discs against the at least one power roller changes the angle.

In a second aspect, the invention is directed to a continuously variable transmission, including a rotatable input shaft, an input disc, a rotatable output shaft, an output disc, a frame, at least one power roller and an engagement mechanism. The input disc is mounted to the input shaft for rotation therewith and for axial movement thereon. The output disc is mounted to the output shaft for rotation therewith and for axial movement thereon. The frame is located between the input and output discs. The frame is fixed axially relative to the input and output discs and is mounted for rotation with respect to the input and output shafts. The at least one power roller is for operatively connecting the input disc and the output disc. The at least one power roller is mounted pivotally to the frame with an offset pivot so that the angle between the at least one power roller and the input and output discs is adjustable. Axial movement of either of the input and output discs against the at least one power roller changes the angle. The engagement mechanism includes a first friction surface attached to the frame, a caliper and an engagement piece. The caliper has a body mounted to a stationary base. The engagement piece is mounted for movement relative to the body and has a second friction surface. The engagement piece is moveable between an engagement position wherein the second friction surface engages the first friction surface and an idling position wherein the second friction surface is spaced from the first friction surface.

In a third aspect, the invention is directed to a continuously variable transmission, including a rotatable input shaft, an input disc, a rotatable output shaft, an output disc, a frame, and at least one power roller. The input disc is mounted to the input shaft for rotation therewith and for axial movement thereon. The output disc is mounted to the output shaft for rotation therewith and for axial movement thereon. The frame is located between the input and output discs. The frame is fixed axially relative to the input and output discs. The at least one power roller is for operatively connecting the input disc and the output disc. The at least one power roller is mounted pivotally to the frame with an offset pivot so that the angle between the at least one power roller and the input and output discs is adjustable. Axial movement of either of the input and output discs against the at least one power roller changes the point of contact between the at least on power roller and the input and output discs respectively.

In a fourth aspect, the invention is directed to a method for changing a transmission ratio on a continuously variable transmission having a rotatable input shaft, an input disc mounted to the input shaft for rotation therewith and for axial movement thereon, a rotatable output shaft, an output disc mounted to the output shaft for rotation therewith and for axial movement thereon, a frame located between the input and output discs, the frame being fixed axially relative to the input and output discs, and at least one power roller for operatively connecting the input disc and the output disc, the at least one power roller being mounted pivotally to the frame with an offset pivot so that the angle between the at least one power roller and the input and output discs is adjustable, so that axial movement of either of the input and output discs against the at least one power roller changes the angle, the method comprising:

axially moving at least one of the input and output discs to cause a change in the angle of the at least one power roller.

In a fifth aspect, the invention is directed to a method for engaging a continuously variable transmission, the transmission including a rotatable input shaft, for rotation about an axis of rotation, the transmission including an input disc, the input disc mounted to the input shaft for rotation therewith and for axial movement thereon, the transmission including a rotatable output shaft, for rotation about the axis of rotation, the transmission including an output disc mounted to the output shaft for rotation therewith and for axial movement thereon, the output disc connected to the output shaft, the transmission including a frame located between the input and output discs, the frame being fixed axially relative to the input and output discs, and mounted for rotation with respect to the input and output shafts, the transmission including at least one power roller for operatively connecting the input disc and the output disc, the at least one power roller being mounted pivotally to the frame with an offset pivot so that the angle between the at least one power roller and the input and output discs is adjustable, so that axial movement of either of the input and output discs against the at least one power roller changes the angle, and the transmission including an engagement mechanism, the engagement mechanism including a first friction surface attached to the frame, and a caliper having a moveable engagement piece, the engagement piece having an second friction surface, the engagement piece moveable between an engagement position wherein the second friction surface engages the first friction surface and an idling position wherein the second friction surface is spaced from the first friction surface, the method comprising:

engaging the first and second friction surfaces to reduce the speed of rotation of the frame.

### DESCRIPTION OF THE DRAWINGS

The present invention will now be described by way of example only with reference to the attached drawings in which:

FIG. 1 is a side view of a continuously variable transmission in accordance with a first embodiment of the present invention;

FIG. 2 is a sectional side view of the transmission of FIG. 1 taken along lines 2-2, in a low-ratio position;

FIG. 3 is a perspective view of a portion of the transmission shown in FIG. 1;

FIG. 4a is an exploded perspective view of an actuator shown in FIG. 2, with some portions cut away for clarity;

FIGS. 4b, 4c and 4d are side views of the actuator shown in FIG. 4a;

FIG. 5 is a sectional side view of the transmission of FIG. 1 in a mid-ratio position;

FIG. 6 is a sectional side view of the transmission of FIG. 1 in a high-ratio position;

FIG. 7 is a sectional side view of a continuously variable transmission in accordance with another embodiment of the present invention, the transmission having a first optional idling mechanism;

FIG. 8 is a sectional side view of a continuously variable transmission in accordance with yet another embodiment of the present invention, the transmission having a second optional idling mechanism;

FIG. 9 is a perspective view of a portion of the transmission shown in FIG. 8; and

FIG. 10 is a sectional side view of a continuously variable transmission in accordance with yet another embodiment of the present invention, the transmission having a third optional idling mechanism.

### DESCRIPTION OF THE PREFERRED EMBODIMENT

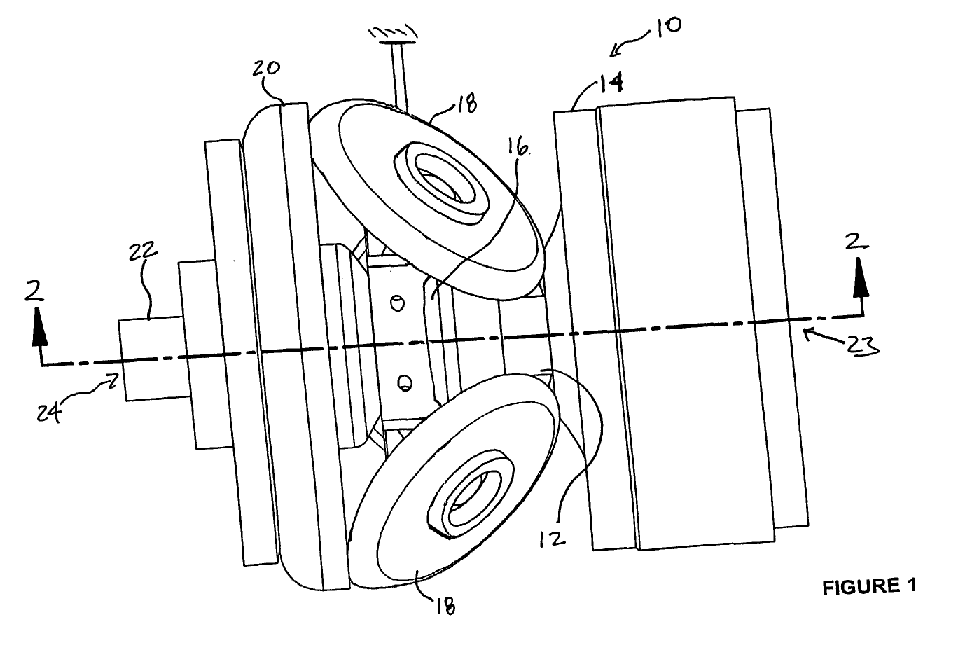

Reference is first made to FIG. 1 which illustrates a continuously variable transmission 10 made in accordance with a first preferred embodiment of the present invention and which will be used for the purposes of describing the operational aspects of the invention.

Transmission 10 can be operatively connected to a power source (not shown), such as for example an electric motor or an internal combustion engine, to drive a mechanical load (not shown), such as, for example, drive wheels on a vehicle. Transmission 10 can transmit power over a continuous range of transmission ratios, so that the optimum ratio can be selected for a given mechanical load.

Transmission 10 includes an input shaft 12, an input disc 14, a power roller assembly 16 including one or more power rollers 18, an output disc 20 and an output shaft 22. Transmission 10 has an input end 23 and an output end 24, which are generally the ends of the transmission on the input and output sides respectively. In general, power is transmitted from the power source (not shown), through the input shaft 12 to the input disc 14, to the power rollers 18, to the output disc 20, and finally to the output shaft 22. From the output shaft 22, the power may be distributed as necessary to drive the mechanical load.

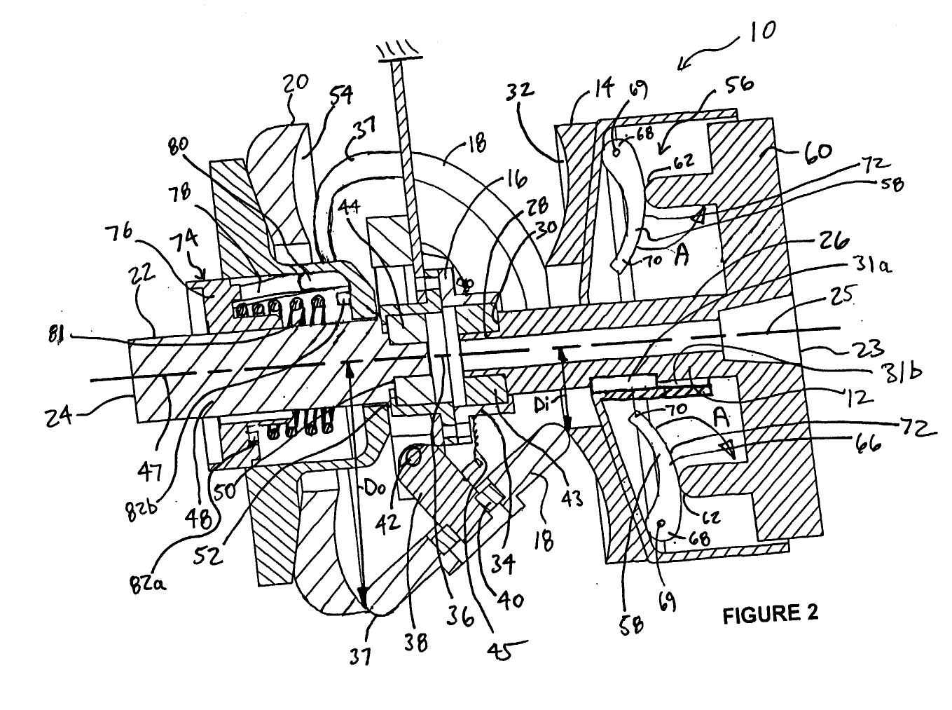

Reference is made to FIG. 2. The input shaft 12 rotates about an input axis 25. The input shaft 12 may be hollow, as shown, or may alternatively be solid. The input shaft 12 includes a main body 26, and a tip portion 28. The tip portion 28 defines a shoulder 30.

The input disc 14 is mounted to the input shaft for rotation therewith and for axial movement thereon. The input disc 14 may be mounted to the input shaft 12 in any suitable way, such as, for example, by means of one or more low-friction sliders 31a, and one or more grooves 31b, as shown. Slider 31a may be attached to the input shaft 12, as shown, and may fit into groove 31b, which may be defined in the input disc 14. Slider 31a and groove 31b permit the sliding movement of input disc 14 along input shaft 12. Also, slider 31a and groove 31b cause input disc 14 to rotate with input shaft 12. Alternatively, the slider 31a may be mounted to the input disc 14 and the groove may be defined in the input shaft 12. Alternatively the input disc 14 may be mounted to the input shaft by a relatively loose spline fit between the input disc 14 and the input shaft 12. Alternatively any other suitable means may be used to connect the input disc 14 to the input shaft 12. The input disc 14 includes an input disc surface 32. The input disc surface 32 is generally partially toroidally shaped, and is the surface through which input disc 14 transmits power to the power rollers 18.

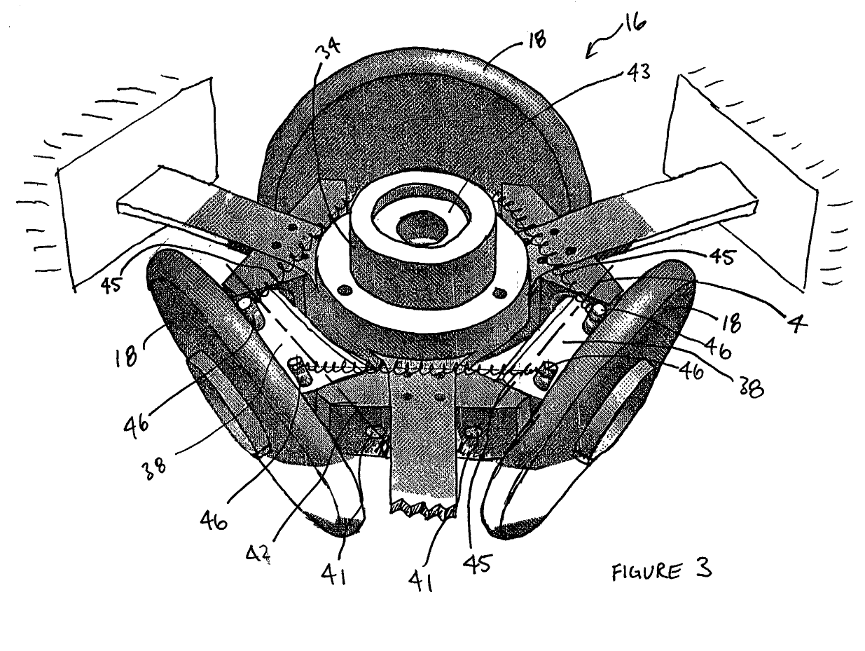

The power roller assembly 16 includes one or more power rollers 18 and a frame 34. The power roller assembly 16 is shown more clearly in FIG. 3. In the case as shown, where there are a plurality of power rollers 18, they may be arranged symmetrically about a frame axis 36, and at a common radius from frame axis 36, as shown. For example, there may be three power rollers 18 arranged symmetrically. The frame axis 36 is preferably co-linear with the input axis 25. The power rollers 18 rotate between the input and output discs 14 and 20, and transmit torque therebetween. The power rollers 18 each have a rim portion 37, which is preferably rounded and which may for example, be made up of a suitably grippy and durable rubber or plastic for improved engagement with the input and output discs 14 and 20. The power rollers 18 are rotatably mounted to swing arms 38, by means of bearings 40. The swing arms 38 are pivotally mounted to frame 34 at a pivot 41. The pivot axis 42 is offset from the plane of the rim portion 37, so that a force against the rim portion 37 causes the power rollers 18 to pivot. The pivot axis 42 is preferably substantially perpendicular to the input axis 25.

The frame 34 may be fixedly mounted to any stationary base, such as, for example, the housing (not shown) for the transmission 10, so that frame 34 remains stationary during the operation of transmission 10. “Stationary” means that the frame is fixed axially with respect to the input and output shafts and that the frame is fixed rotationally (ie. it is prevented from rotating) about frame axis 36. The frame 34 may optionally include input and output bearings 43 and 44 which mount between the frame 34 and the tip portions 28 and 50 respectively for supporting the input and output shafts 12 and 22 respectively.

The power roller assembly 16 may optionally include one or more springs 45. Springs 45 bias the power rollers 18 against the input disc 14, for engagement with the input disc 14. Furthermore, springs 45 bias the input disc 14 towards the input end 23 of the transmission 10. Springs 45 may be, for example, tension springs, as shown, and may be mounted on spring mounts 46, extending between adjacent swing arms 38 on the input side of the power roller assembly 16. The mounting of springs 45 is shown more clearly in FIG. 3. Alternatively, springs 45 may be torsion springs mounted in the pivotal joint of the swing arms 38 to the frame 34. Alternatively, the springs 45 may be any other suitable biasing means.

The output shaft 22 supports the output disc 20 for rotation about an output axis 47, and for axial movement along output axis 47. The support means connecting the output disc 20 to the output shaft 22 may be any suitable support means, such as that used to connect the input disc 14 to the input shaft 12. Alternatively, the support may be by means of an actuator 74, which is discussed further below, and which is shown in the Figures. Output axis 47 is preferably co-linear with the input axis 25. The output shaft 22 is preferably hollow, and includes a main body 48, and a tip portion 50. The tip portion 50 defines a shoulder 52. Shoulder 52 acts as a limit for the travel of the output disc 20 on the output shaft 22.

The output disc 20 includes an output disc surface 54. The output disc surface 54 is generally partially toroidally shaped, and is the surface through which power is transmitted from the power rollers 18 which, in turn, receive power from the input disc 14.

The transmission 10 transmits torque and rotational speed from the input disc 14 to the output disc 20 according to a transmission ratio that depends on the angle of the power rollers 18, and more particularly, the transmission ratio depends directly on the distance Di to Do, where Di is the distance from the point of contact of each of the power rollers 18 with the input disc 14 to the input axis 25, and Do is the distance from the point of contact of each of the power rollers 18 with the output disc 20 to the output axis 47. Thus, as the angle of each of the power rollers 18 changes, the points of contact between each of the power rollers 18 and the input and output discs 14 and 20 respectively change, and the transmission ratio changes.

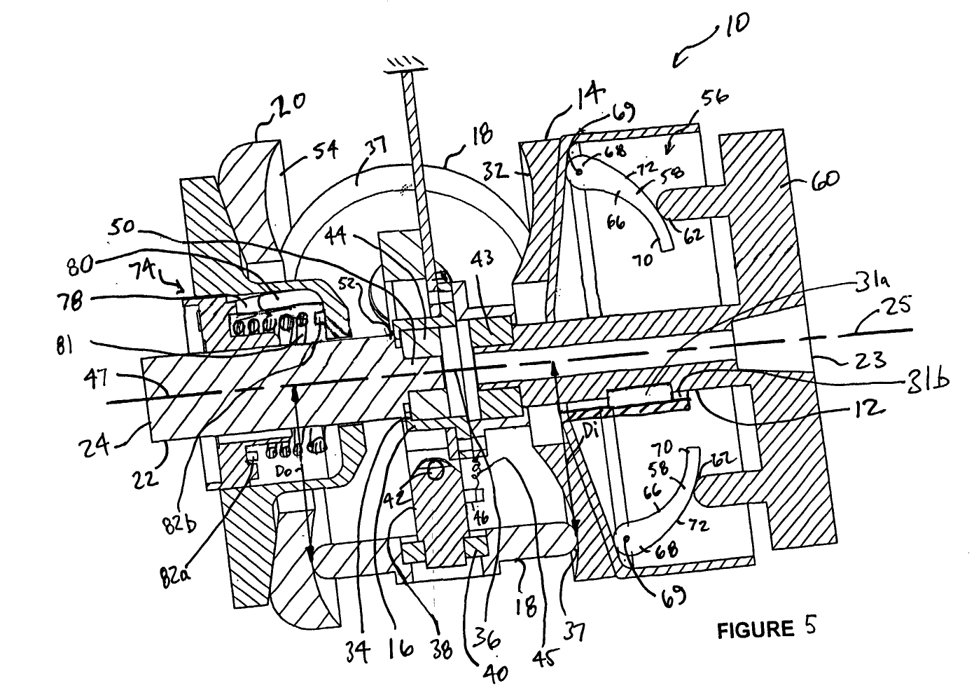

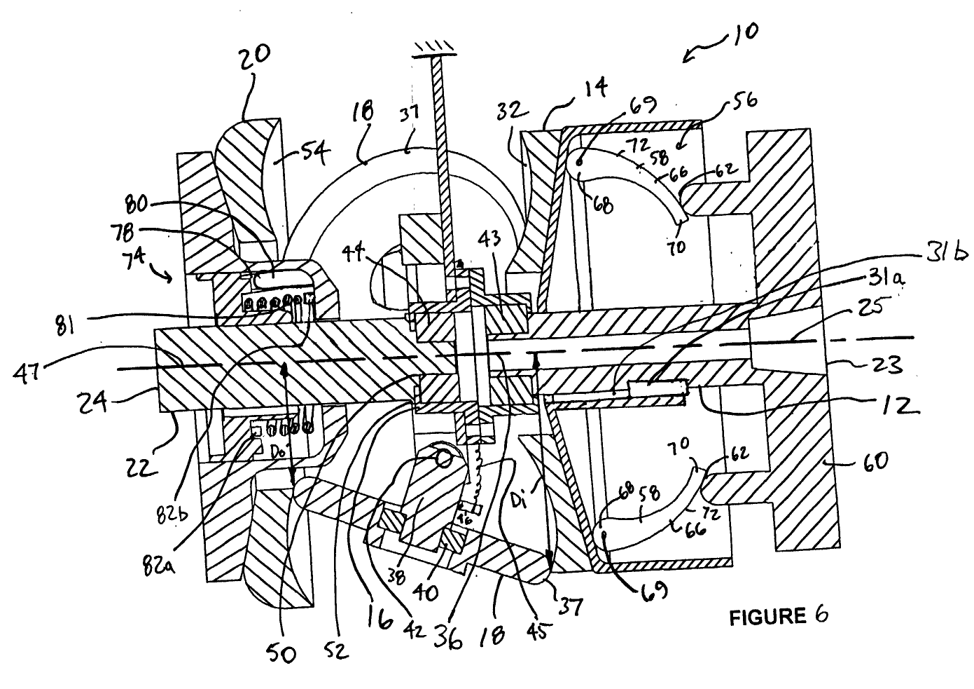

Axial movement of either of the input disc 14 or the output disc 20 against the rim portion 37 of the power rollers, causes the power rollers 18 to pivot towards the other of the input disc 14 or the output disc 20, changing their angle relative to the input and output discs 14 and 20. Thus, to change the transmission ratio, the input or output discs 14 or 20 may be moved axially against the power rollers 18, until a selected transmission ratio is achieved. The transmission 10, as shown in FIG. 2, is arranged to reduce the rotational speed and increase the torque from the input disc 14 to the output disc 20. As shown in FIG. 5, the transmission 10 is arranged to transfer both torque and rotational speed with no change from the input disc 14 to the output disc 20. As shown in FIG. 6, the torque is decreased and the rotational speed is increased from the input disc 14 to the output disc 20.

Optionally included with transmission 10 is an actuator 56, for sliding input disc 14 on the input shaft 12. Actuator 56 may be any suitable actuation means for translating the input disc 14 on the input shaft 12. Actuator 56 may be a manual actuator, or may be automatic as shown, responding to one or more conditions during operation. Actuator 56 may for example, include one or more centrifugal weights 58, a mounting plate 60 with one or more cam surfaces 62. The mounting plate 60 rotates with the input shaft 12, but is not axially moveable along the input shaft 12. The mounting plate 60 may be keyed or otherwise mounted to the input shaft 12 for rotation with the input shaft 12, or may alternatively be integrally formed with the input shaft 12, as shown. The centrifugal weights 58 may, for example, be attached to the input disc 14, and the cam surfaces 62 may be on the mounting plate 60, as shown, or vice versa. Whichever is mounted to the mounting plate 60 may alternatively be mounted directly to any suitable portion of the input shaft 12. The centrifugal weights 58 each have a body 66, which has an attached end 68 and a free end 70. The attached end 68 is pivotally attached by a pivot pin 69 to the input disc 14. During rotation of the input shaft 12 and input disc 14, the free ends 70 of the centrifugal weights 58 swing outwards in response to an increase in rotational speed of the input shaft 12, in the direction shown by the arrow A. Conversely, a decrease in the rotational speed of the input shaft 12 causes the free end 70 to retract radially. Weights 58 each have a cam surface 72. Cam surface 72 engages cam surface 62 throughout the range of motion of the weights 58. As the speed of the input shaft 12 increases, the force of the weights 58 against the cam surfaces 62 pushes the input disc 14, and, in turn, the power rollers 18 and the output disc 20 towards the output end 24. Movement of the power rollers towards the output end 24 causes the springs 45 to extend. As the input shaft speed increases the weights 58 extend further outwards, and push the input disc 14, the power rollers 18 and the output disc 20 farther along towards the output end 24, causing the springs 45 to further extend. As the speed of the input shaft 12 decreases, the weights 58 retract, and the tension force in the springs 45 pulls the power rollers 18 and the input disc 14 towards the input end 23. The movement of the input disc 14, the power rollers 18 and the output disc 20 towards the output end 24 (in response, for example, to an increase in speed), is shown in the progression from FIG. 2 to FIG. 5 and finally to FIG. 6. The movement of these components towards the input end 23, (in response, for example, to a decrease in speed), is shown by the reverse progression of figures.

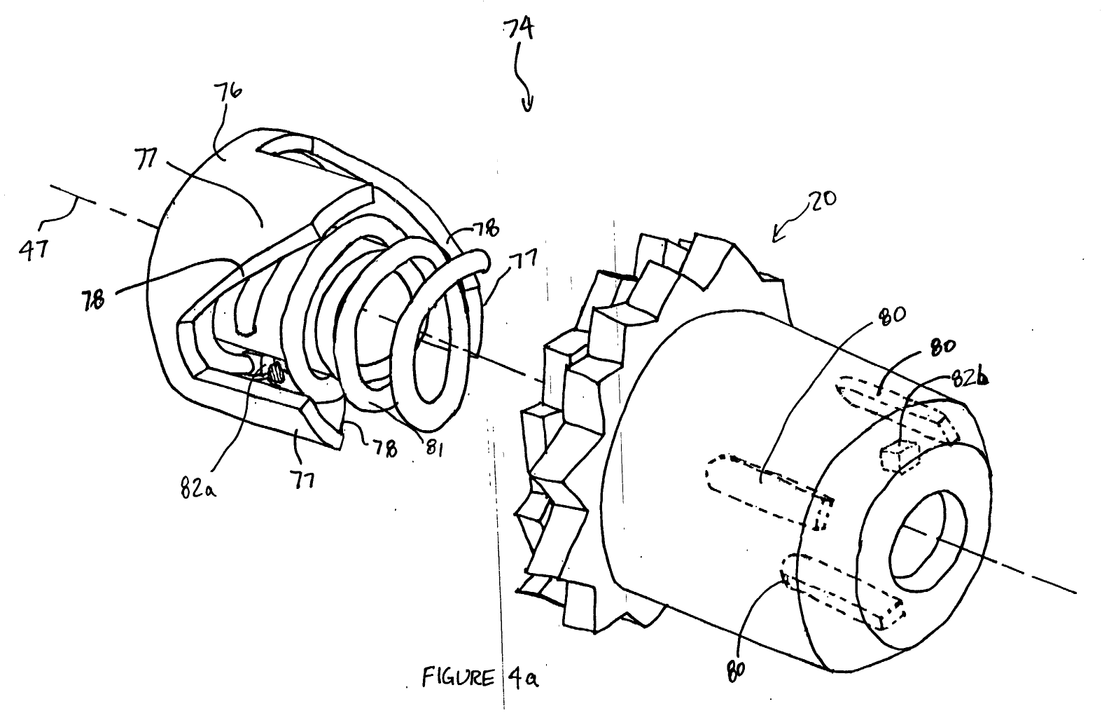

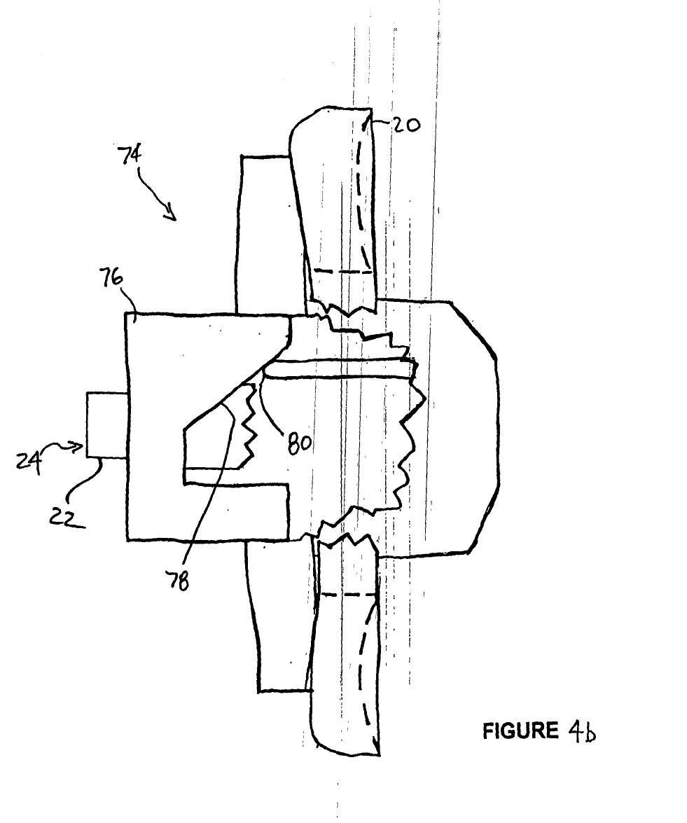

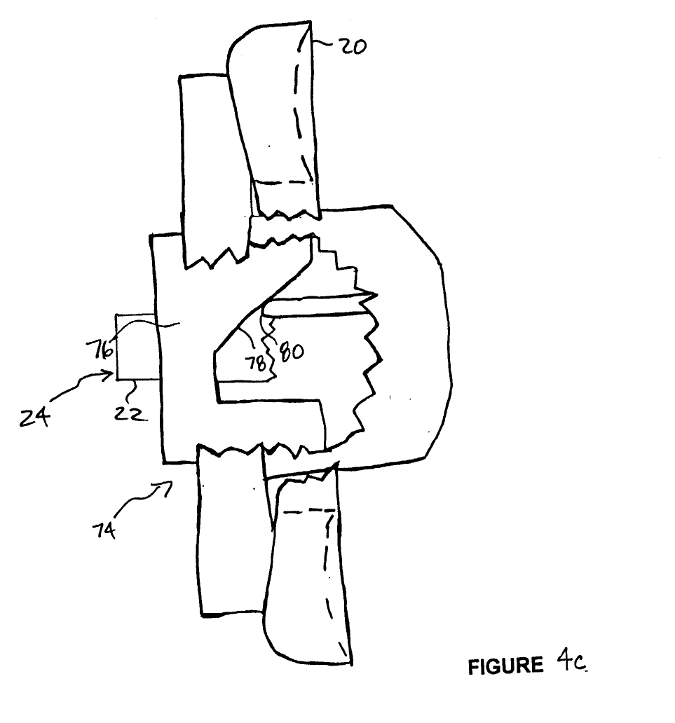

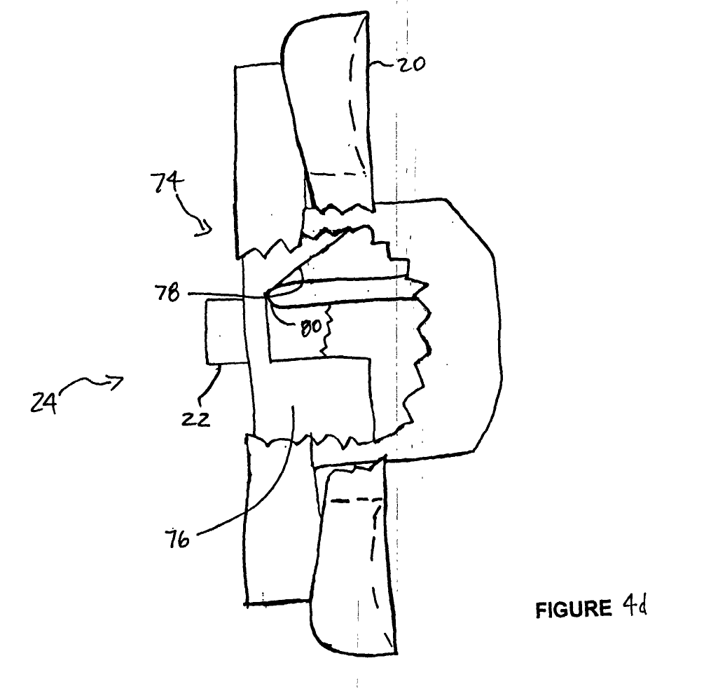

As another option for transmission 10, an actuator 74 may be included for axially moving the output disc 20 on the output shaft 22, which is more clearly illustrated in FIG. 4a. Actuator 74 may be a manual actuator, or may be automatic as shown, responding to one or more conditions during operation. Actuator 74 may, for example, include a hollow cylindrical member 76 with one or more cams 77 having helical cam surfaces 78, one or more cam followers 80 and a biasing mechanism 81. The cams 77 may be mounted to the cylindrical member 76 and the cam followers 80 may be mounted to the output disc 20, as shown, or vice versa. Whichever is mounted to the cylindrical member 76 may alternatively be mounted directly to any suitable part of output shaft 22. The cylindrical member 76 is fixed to and rotates with the output shaft 22, and is not axially moveable along the output shaft 22. The cylindrical member 76 may alternatively be keyed, as shown, or otherwise mounted to the output shaft 22 for rotation with the output shaft 22, or may alternatively be integrally formed with the output shaft 22. The cam surfaces 78 may extend in a helical path about the circumference of member 76, so that they extend partially circumferentially around the member 76 and partially axially. The cam followers 80 may be integrally formed on the inside surface of the hub portion of the output disc 20, as shown in FIG. 4a. The cam followers 80 may be low-friction sliders or may alternatively be rollers. The cam followers 80 engage the cam surfaces 78 at all speeds of rotation of the output disc 20 and output shaft 22. In the embodiments shown in the figures, the engagement of the cam followers 80 and the cam surfaces 78 transfers torque from the output disc 20 to the output shaft 22.

The biasing mechanism 81 may be any suitable biasing means for biasing the output disc in the direction of the input end 23. For example, biasing mechanism 81 may be a coil spring that acts both as a compression spring and as a torsion spring. Biasing mechanism 81 may be retained on the inside surfaces of the cylindrical member 76 and the hub of the output disc 20. Furthermore, the ends of biasing mechanism 81 may be positioned against a boss 82a on the inside surface of the cylindrical member 76, and a boss 82b on the inside surface of the output disc 20. Biasing mechanism 81 biases the cam followers 80 and the cam surface 78 against each other to provide improved engagement between them. Biasing mechanism 81 also biases the output disc 20 towards the input disc 14, to provide improved engagement of the discs 14 and 20 on the power rollers 18. An alternative biasing mechanism may bias the input disc 14 towards the output disc 20.

In the embodiment shown in the Figures, the output disc 20 is connected to the output shaft 22 for rotation therewith, and for axial movement thereon, by means of actuator 74.

Reference is made to FIGS. 4b, 4c and 4d, which show the operation of actuator 74 in more detail. During operation of the transmission 10, power and rotation are transmitted from the power source (not shown), through the transmission to the output shaft 22. A mechanical load (not shown) exists on the output shaft 22. The rotation of the input disc generates an axial force on the input disc 14, power rollers 18 and output disc 20, towards the output end 24 of the transmission, thus keeping all the components engaged, as explained above. In response to the rotational force exerted by the power rollers 18 on the output disc surface 54, a force is, in turn, exerted from the cam followers 80 to the cam surface 78 on the cylindrical member 76. This force generates a torque on the output shaft 22. If the generated torque is greater than that required for the mechanical load, the force of the cam followers 80 rotationally advances the cylindrical member 76 and the output shaft 22, relative to the output disc 20. Thus, when the cylindrical member 76 rotationally advances the output disc 20, the input disc 14 and the power rollers 18 will move towards the output end 24, (to the left as drawn), because of the helical configuration of the cam surfaces 78, combined with the axial force generated from the centrifugal weights to keep all the components together. This movement is illustrated for the actuator 74 in the progression from FIGS. 4b to 4c and finally to 4d, and is illustrated for the input disc 14, power rollers 18 and output disc 20 by the progression from FIG. 2 to FIG. 5 and finally to FIG. 6. The force of the input disc 14 and the power rollers 18 to move axially towards the output end 24 pushes the output disc 20 towards the output end 24, and causes output disc 20 to compress biasing mechanism 81. This movement towards the output end 24 changes the angle on the power rollers 18 so that the torque transmitted to the output disc 20 is decreased. This movement continues until the torque generated by the cam followers 80 against the cam surface 78 reaches equilibrium with the resistive torque from the load. Because the ends of the biasing mechanism 81 are held against bosses 82a and 82b, the rotational advancement of the cylindrical member 76 relative to the output disc 20 causes the biasing mechanism 81 to experience torsion.

If, during operation, the generated torque is less than that required to meet the mechanical load on the output shaft 22, then the output disc 20, in order to rotate will ride along the cam surface 78, and consequently moves axially towards the input disc 14, as shown by the progression from FIGS. 4d to 4c and finally to 4b, for the actuator 74, and the progression from FIG. 6 to FIG. 5 to FIG. 2. As the output disc 20 (more specifically, its cam followers 80) rides along the cam surface 78, the output disc 20 pushes against the power rollers 18 and, in turn, against the input disc 14, moving the power rollers 18 and the input disc 14 away from the output end 24 and towards the input end 23. Since the frame 34 supporting the power rollers 18 is fixed, this movement of the output disc 20 and the input disc 14 changes the angle of the power rollers 18, with respect to the input and output discs 14 and 20, (eg, from the position shown in FIG. 6 to the position shown in FIG. 5, or from the position shown in FIG. 5 to the position shown in FIG. 2). This increases the transmission ratio, so that the torque transmitted from the input disc 14 to the output disc 20 is increased. Throughout this movement towards the input end 23, the biasing mechanism 81 is in some state of torsion, and therefore exerts a rotational force on the output disc 20 so that cam followers 80 remain engaged with cam surface 78. The movement of the output disc 20 towards the input end 23 continues until the torque generated reaches equilibrium with the torque required for the mechanical load on the output shaft 22. If the mechanical load on the output shaft 22 is so large that the torque generated by the transmission 10 when the components are moved as far as possible to the input end 23 is still not enough, then the load simply prevents the transmission 10 from rotating.

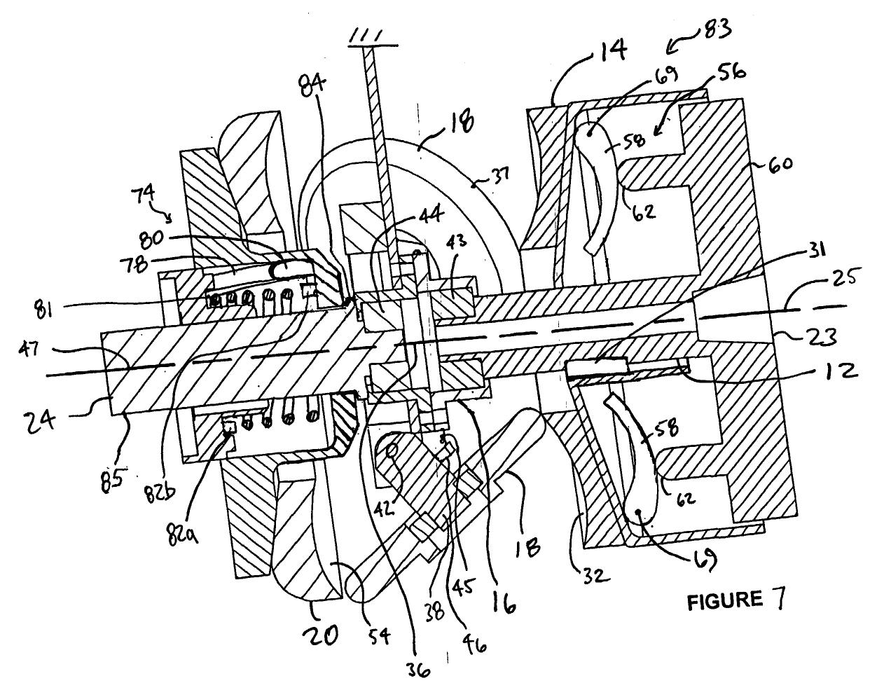

Reference is made to FIG. 7, which shows a transmission 83. Transmission 83 is similar to transmission 10, but has an optional idling capability. Transmission 83 includes the same components as transmission 10 except as follows. In order to provide idling capability to transmission 83, the travel of the output disc 20 is limited by a shoulder 84 on output shaft 85. Output shaft 85 is similar to output shaft 22, except that shoulder 84 is positioned closer to the output end 24, relative to shoulder 52 on output shaft 22. When it is desired for the transmission 83 to idle, the input disc 14 is moved to the idling position (as shown in the figure), proximate the mounting plate 60. The power rollers 18 are preferably biased towards the input disc 14 by springs 45, but they may alternatively be biased towards the output disc 20 by any suitable biasing means, such as springs. Once the input disc 14 is moved to the idling position, the travel of the output disc 20 is limited by shoulder 84, so that the gap between the input and output discs 14 and 20 will be too large for the power rollers 18 to contact both discs 14 and 20 at the same time. Thus, in the idling position, the power rollers 18 cannot transmit power from the input disc 14 to the output disc 20. When the transmission 83 is to be engaged, the input disc 14 is moved towards the output end 24 until the gap between the input disc 14 and the output disc 20 is reduced so that the input disc 14, the power rollers 18 and the output disc 20 are all engaged. The movement of the input disc 14 may be by means of actuator 56, or by any other suitable means. The shoulder 84 on the output shaft 85, may be positioned so that the engagement of the transmission 83 occurs at any selected rotational speed for the input shaft 12, such as, for example, 2500 rpm.

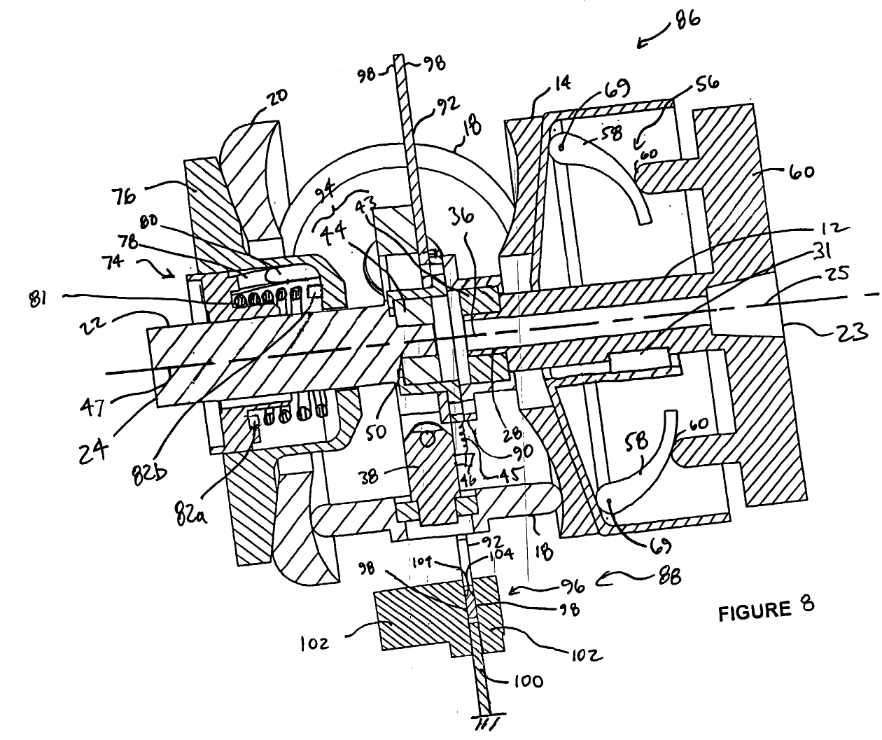

Reference is made to FIG. 8, which shows a transmission 86, which is similar to transmission 10, but includes an alternative optional idling mechanism 88. The components of transmission 86 are the same as those of transmission 10 except as follows. Frame 34 is replaced by a frame 90, which is rotatable about frame axis 36. Idling mechanism 88 comprises a friction ring 92, a rotation assembly 94 and a caliper 96. The friction ring 92 is attached to frame 90, and has at least one first friction surface 98. The friction ring 92 in the embodiment shown, has two first friction surfaces 98.

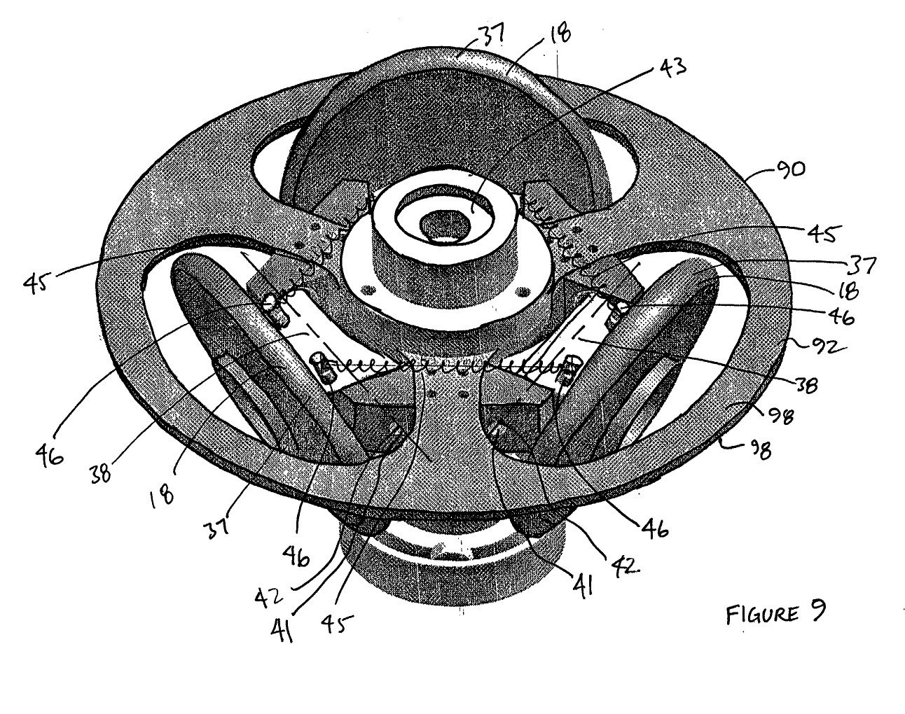

The frame 90, rather than being fixed to a stationary base, is mounted only to the rotation assembly 94. The rotation assembly 94 may, for example, consist of the bearings 43 and 44 which are positioned on the tip portions 28 and 50 of the input and output shafts 12 and 22 respectively. Frame 90 is shown more clearly in FIG. 9.

Referring back to FIG. 8, the caliper 96 has a body 100 and at least one engagement piece 102. The body 100 is fixedly mounted to a stationary base. The engagement piece 102 has a second friction surface 104. The caliper 96 in the embodiment shown, has two engagement pieces 102, each with a second friction surface 104. The engagement pieces 102 are moveable with respect to the body 100, so that they can move from an idling position wherein the second friction surfaces 104 do not engage the first friction surfaces 98, to an engagement position where the second friction surfaces 104 engage the first friction surfaces 98. The engagement pieces 102 may move between the engagement and idling positions by means of hydraulic fluid pressure and appropriate valving, or by cable actuation similar to that used in standard bicycle hand brakes, or by any other suitable actuation means known. The engagement pieces 102 may be biased by springs or by any other biasing means to be in the engagement position, requiring actuation of the hydraulic pressure or the cable mechanism to release the pieces 102, and move them to the idling position. The engagement pieces 102 may alternatively be biased by the springs or biasing means to be in the idling position.

In the idling position, because the first and second friction surfaces 98 and 104 are not engaged, the frame 90 and the power rollers 18 are free to rotate about the frame axis 36. An example of the operation of the idling mechanism 94 may be found when the input and output shafts 12 and 22 begin at rest. When the input shaft 12 and input disc 14 are rotated, the rotation is transferred to the power rollers 18. When the power rollers 18 rotate against the output disc 20, however, the frame 90 will give, since there is little or no resistance to its rotation, while the output disc 20 remains stationary or near stationary, particularly if there is a mechanical load placed on the output shaft 22. Thus the frame 90 will rotate about axis 36, as the power rollers 18 ‘roll’ on the output disc 20. The output disc 20 remains stationary, or may alternatively rotate relatively slowly, depending on the load on the output shaft 22.

In the engagement position, however, the frame 90 is held in position. Thus, power and rotational speed can be transferred between the input and output discs 14 and 20. A smooth engagement may be obtained by controlling the actuation force of the caliper 96 on the friction ring 92, so that the caliper 96 gradually engages the friction ring 92, causing the speed of rotation of the frame 90 about axis 36 to gradually decrease, in turn causing a gradual increase in the transfer of power from the power rollers 18 to the output disc 20.

As yet another option, the transmission may include both systems for idling. Alternatively, the transmission may include any suitable clutch mechanism upstream or downstream from the transmission in the drive train to permit idling.

The caliper 96 and friction ring 92 may alternately be replaced by any other similar mechanism for releasably engaging the frame 90. For example, a drum and shoe brake system may alternatively be used, whereby the drum is mounted to the frame instead of the friction ring 92 and one or more shoes may be used to engage the drum.

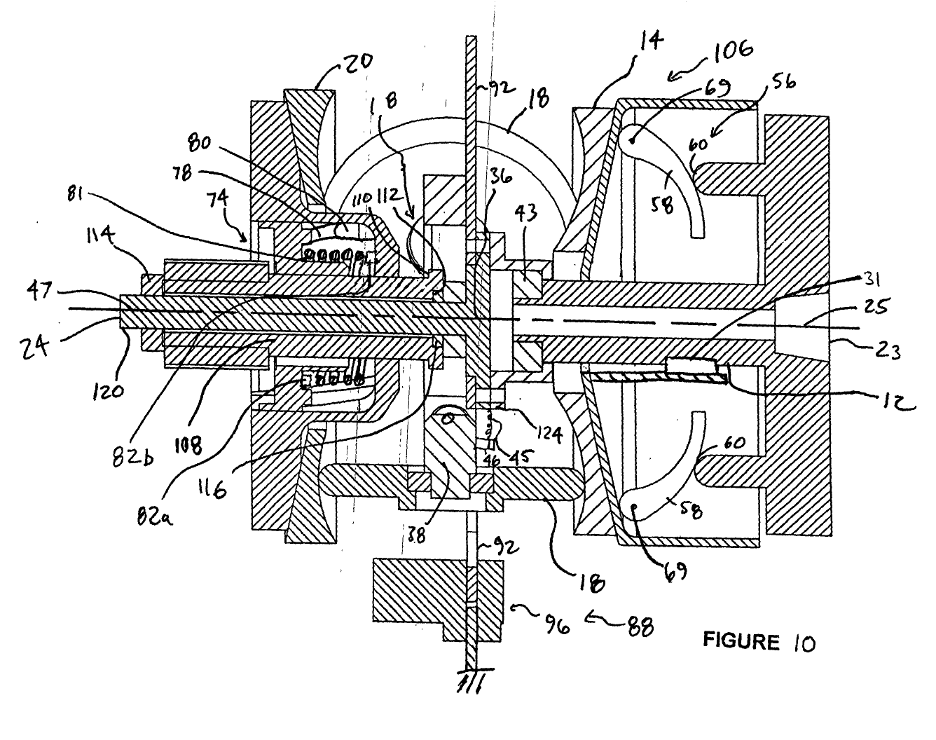

Reference is made to FIG. 10, which shows a transmission 106. Rather than supporting the rotation of the power roller frame on the input and output shafts as is done with transmission 86, transmission 106 at least partially supports the rotation of the power roller frame on a separate shaft. Transmission 106 is similar to transmission 86 of FIG. 8 and includes the same components as transmission 86 except as follows. Output shaft 108 replaces output shaft 22. Output shaft 108 is similar to output shaft 22 except that output shaft 108 includes a tip portion 110, which has a shoulder 112 for limiting the travel of the output disc 20, and which has an internal shoulder 114 for holding a bearing 116.

A rotation assembly 118 replaces rotation assembly 94. Rotation assembly 118 includes a power roller frame shaft 120 and bearings 114, 122 and 43. The power roller frame shaft 120 passes through the output shaft 108 (which is hollow), to support the power roller frame 124 (which replaces frame 90). Alternatively, if the input shaft 12 were hollow, then the power roller frame shaft 120 could extend through the input shaft 12 to support the power roller frame 124. The shaft 120 rotates within bearings 114 and 122. Frame 124 is supported in part by the shaft 120, and in part by bearing 43 on the input shaft 12 for rotation about frame axis 36.

As will be apparent to persons skilled in the art, various modifications and adaptations of the apparatus described above may be made without departure from the present invention, the scope of which is defined in the appended claims.

1. A continuously variable transmission, comprising:
a rotatable input shaft;
an input disc mounted to said input shaft for rotation therewith and for axial movement thereon;
a rotatable output shaft;
an output disc mounted to said output shaft for rotation therewith and for axial movement thereon;
a frame located between said input and output discs, said frame being fixed axially relative to said input and output shafts; and
at least one power roller for operatively connecting said input disc and said output disc, said at least one power roller being mounted pivotally to said frame with an offset pivot so that the angle between said at least one power roller and said input and output discs is adjustable, so that axial movement of either of said input and output discs against said at least one power roller changes said angle.

2. A continuously variable transmission as claimed in claim 1, further comprising at least one biasing mechanism for biasing at least one of said input and output discs towards the other, for said input and output discs to move axially in unison when said transmission is engaged and a change in said angle is required.

3. A continuously variable transmission as claimed in claim 1, further comprising an actuator for axially moving said input disc, said actuator comprising at least one centrifugal weight, said at least one centrifugal weight being pivotally connected to one of said input disc and said input shaft, for said at least one centrifugal weight to swing radially outwardly as a function of the rotational speed of said input disc and said input shaft, said actuator including at least one cam surface attached to the other of said input disc and said input shaft, said at least one cam surface cooperating with said at least one centrifugal weight to move said input disc axially on said shaft.

4. A continuously variable transmission as claimed in claim 3, wherein said at least one cam surface cooperates with said at least one centrifugal weight to move said input disc axially on said shaft in a direction towards said output disc.

5. A continuously variable transmission as claimed in claim 3, wherein said at least one centrifugal weight has a body, said body having an attached end and a free end, said body being pivotally connected to one of said input disc and said input shaft, so that said free end can extend radially outwardly as a function of the rotational speed of said input disc and said input shaft.

6. A continuously variable transmission as claimed in claim 1, further comprising an actuator for axially moving said output disc, said actuator comprising at least one cam connected to one of said output disc and said output shaft, and at least one cam follower connected to the other of said output disc and said output shaft, said cam having a cam surface that extends generally helically about said output shaft, wherein said at least one cam follower is adapted to engage said at least one cam surface to move said output disc axially relative to said cam.

7. A continuously variable transmission as claimed in claim 1, wherein said input disc is axially moveable on said input shaft to an idling position; the continuously variable transmission further comprises a shoulder for limiting the travel of said output disc in the direction of the input disc, so that when said input disc is in said idling position, the minimum gap between said input and output discs is too large for said power rollers to contact both of said input and output discs simultaneously.

8. A continuously variable transmission, comprising:
a rotatable input shaft;
an input disc mounted to said input shaft for rotation therewith and for axial movement thereon;
a rotatable output shaft;
an output disc mounted to said output shaft for rotation therewith and for axial movement thereon;
a frame located between said input and output discs, said frame being fixed axially relative to said input and output discs, and mounted for rotation with respect to said input and output shafts;
at least one power roller for operatively connecting said input disc and said output disc, said at least one power roller being mounted pivotally to said frame with an offset pivot so that the angle between said at least one power roller and said input and output discs is adjustable, so that axial movement of either of said input and output discs against said at least one power roller changes said angle; and
an engagement mechanism, said engagement mechanism including a first friction surface attached to said frame, and a caliper having a body mounted to a stationary base and an engagement piece mounted for movement relative to said body, said engagement piece having a second friction surface, said engagement piece moveable between an engagement position wherein said second friction surface engages said first friction surface and an idling position wherein said second friction surface is spaced from said first friction surface.

9. A continuously variable transmission as claimed in claim 8, wherein in said engagement position, said caliper is adapted to stop the rotation of said frame.

10. A continuously variable transmission as claimed in claim 8, wherein in said engagement position, said caliper is adapted to stop the rotation of said frame gradually.

11. A continuously variable transmission as claimed in claim 8, wherein in said engagement position, said caliper is adapted to reduce the speed of rotation of said frame.

12. A continuously variable transmission, comprising:
a rotatable input shaft;
an input disc mounted to said input shaft for rotation therewith and for axial movement thereon;
a rotatable output shaft;
an output disc mounted to said output shaft for rotation therewith and for axial movement thereon;
a frame located between said input and output discs, said frame being fixed axially relative to said input and output shafts; and
at least one power roller for operatively connecting said input disc and said output disc, said at least one power roller being mounted pivotally to said frame with an offset pivot so that the angle between said at least one power roller and said input and output discs is adjustable, so that axial movement of either of said input and output discs against said at least one power roller changes the points of contact between said at least one power roller and said input and output discs respectively.

13. A method for changing a transmission ratio on a continuously variable transmission having a rotatable input shaft, an input disc, the input disc being mounted to the input shaft for rotation therewith and for axial movement thereon, a rotatable output shaft, an output disc, the output disc mounted to the output shaft for rotation therewith and for axial movement thereon, a frame located between the input and output discs, the frame being fixed axially relative to the input and output shafts, and at least one power roller for operatively connecting the input disc and the output disc, the at least one power roller being mounted pivotally to the frame with an offset pivot so that the angle between the at least one power roller and the input and output discs is adjustable, so that axial movement of either of the input and output discs against the at least one power roller changes the angle, the method comprising:
axially moving at least one of the input and output discs towards the other to change the angle of said at least one power roller.

14. A method for engaging a continuously variable transmission, the transmission having a rotatable input shaft, an input disc, the input disc being mounted to the input shaft for rotation therewith and for axial movement thereon, a rotatable output shaft, an output disc, the output disc mounted to the output shaft for rotation therewith and for axial movement thereon, a frame located between the input and output discs, the frame being fixed axially relative to the input and output discs, and mounted for rotation with respect to the input and output shafts, the transmission including at least one power roller for operatively connecting the input disc and the output disc, the at least one power roller being mounted pivotally to the frame with an offset pivot so that the angle between the at least one power roller and the input and output discs is adjustable, so that axial movement of either of the input and output discs against the at least one power roller changes the angle, and the transmission including an engagement mechanism, the engagement mechanism including a first friction surface attached to the frame, and a caliper having a moveable engagement piece, the engagement piece having an second friction surface, the engagement piece moveable between an engagement position wherein the second friction surface engages the first friction surface and an idling position wherein the second friction surface is spaced from the first friction surface, the method comprising:
engaging the first and second friction surfaces to reduce the speed of rotation of the frame.

15. A method for engaging a continuously variable transmission as claimed in claim 14, wherein the step of engaging the first and second friction surfaces stops the rotation of the frame.

16. A method for engaging a continuously variable transmission as claimed in claim 14, wherein the step of engaging the first and second friction surfaces includes gradually engaging the first and second friction surfaces, to permit the smooth engagement of the transmission.
